(19) United States
(12) Patent Application Publication
(10) Pub. No.: US 2009/0276222 A1
(43) Pub. Date: Nov. 5, 2009

(54) Method and system for incorporating one or more inputs and defining and applying a plurality of rules for the different stages of speech and video analytics systems

(75) Inventor: Raman Ramesh, Alpharetta, GA (US)

Correspondence Address: Raman Ramesh, 210 Chelsey Circle, Alpharetta, GA, 30004, US

(73) Assignee: CYBERTECH INFORMATION INTERNATIONAL, INC., Alpharetta, GA (US)

(21) Appl. No.: 12/434,595

(22) Filed: May 1, 2009

Related U.S. Application Data
(60) Provisional application No. 61/049,670, filed on May 1, 2008.

(51) Int. Cl. G10L 21/00

(52) U.S. Cl. 704/270; 704/E21.019

(57) ABSTRACT

A method and system for improving the context and accuracy of speech and video analytics searches by incorporating one or more inputs and defining and applying a plurality of rules for the different stages of said speech and video analytics system searches.

### CROSS-REFERENCE TO RELATED APPLICATIONS

This application claims the benefit under 35 USC 119(e) to U.S. Provisional Application Ser. No. 61/049,670 USING DYNAMIC RULES FOR PRE AND POST SPEECH ANALYTICS SEARCHES AND FOR SPEECH GRAMMAR AND EXPRESSIONS filed May 1, 2008, which is incorporated herein by reference for all purposes.

### FEDERALLY SPONSORED RESEARCH

Not applicable

### SEQUENCE LISTING OR PROGRAM

Not applicable

### TECHNICAL FIELD

The invention relates generally to computer software and more particularly where live and recorded audio and video are used in storage, search and retrieval

### BACKGROUND OF THE INVENTION

### Prior Art

Search and analysis of audio and video containing recorded audio are used by government and military agencies such as Homeland Security and National Security Agency for proactively monitoring and collecting actionable intelligence from live and recorded data and quickly responding to critical security threats and law enforcement issues. In the commercial arena, it is used for analytics of live and recorded audios and videos in Contact Center applications, Rich Media applications which include audio and video, and Legal applications so that actionable intelligence can be applied to improving customer service, pro-active problem resolution, large media search where a library of multimedia content is searchable and accessible and in legal applications for legal discovery and compliance review respectively. It has been generally recognized that extracting information of specific interest in a cost efficient manner in mining audio and video data can be a challenging task. U.S. Pat. No. 7,526,425 Method and system for extending keyword searching to syntactically and semantically annotated data elaborates the difficulty in searching large sets of unstructured data and proposes a method for extending keyword searching to syntactically and semantically annotated data. Most audio and video mining systems are restricted in their ability to incorporate rules during different stages of audio and video mining and incorporating data from external sources.

Speech Analytics is a term used to describe automatic methods of analyzing speech, usually from recorded conversations, to extract useful information about the speech content or the speakers. One use of speech analytics applications is to spot spoken keywords or phrases, either as real-time alerts on live audio or as a post-processing step on recorded speech. This technique is also known as audio mining. Speech Analytics allows us to search terms of interest to:

Locate where in the audio the search term was said

Locate how many ‘hits’ of the search term occurred

Categorizing and prioritizing the search terms etc.

Speech Grammar is a collection of symbols and guidelines that can be used to build and order complex phrases for searching (speech mining). For example (hi or hello or good morning or good afternoon) and (thanks or thank you) for calling

Speech Expressions are expressions build using the speech grammar or alternative notations for example Regular Expressions.

Speech Mining refers to searching the media for relevant phrases/patterns.

While the current methods of creating and applying rules and incorporating inputs from different sources for:
1. Extraction of metadata and media,
2. Search (mining media), and
3. Analysis and display of results of speech analytics searches and creation and use of search grammar and expressions
   have been successful in their ability to provide context and accuracy in certain restricted ways, they preclude the possibility of relaxing the constraints under which they presently operate.

For example, existing systems do not allow inclusion of inputs dynamically from varying sources, dynamic changes to the grammar and application of complex rules.

Current systems also suffer from the following drawbacks:

Typically the contact metadata from Computer Telephone Integration (CTI) and call metadata are used for extraction of the metadata and media into the said speech analytics system and addition of other and varying new inputs from internal and external sources is restricted

The speech grammar and expressions used in searches is fixed and cannot be changed to incorporate new and varying operators and other information like threshold limits, information from Customer Relationship Management Systems (CRM), CTI etc.

Current systems do not provide ways to dynamically altering, managing and using rules during the different stages of Speech Analytics

Current systems do not provide ways to create, store and deploy rules across all the above stages.

These drawbacks can be overcome with the attendant features and advantages of the present invention

### BACKGROUND

### Objects and Advantages

The Speech Analytics process usually incorporates rules during the following three stages:

1. Extraction of the metadata and media for processing by the Speech Engines: In this stage, a subset of the metadata and media are extracted into the speech analytics system. This is done because speech processing consumes a lot of resources both in terms of storage and processing power so only the media of interest and related metadata are extracted. This is done by having rules created based on the metadata for extraction of metadata and media into the system

For example:

In a contact center environment the metadata that is usually used for extraction include, unique contact id, start time of contact recording, duration of the recording and duration of the call. The metadata used during the extraction phase are usually fixed. Some systems incorporate a fixed number of used defined data but these are pre-configured and cannot be dynamically altered

2. Search expressions are created using words and phrases of interest and the speech grammar notation defined for the system. Rules are applied for performing search on the media

For example: A sample search expression may be represented as:
(5)(hi|hello|good morning|good afternoon|good evening)+(thanks|thank you) which can be interpreted as searching for:

After 5 seconds of start of the media look for any of the terms hi, hello, good morning, good afternoon or good evening followed by thanks or thank you

Current systems do not provide ways to incorporate new operand and operators in an adhoc fashion. Also, said systems usually do not have a repository for storage, retrieval and management of rules.

3. Post processing rules applied to the results of the searches in current systems are inflexible

For example:

For the question, “How many people within area code 30004 and age between 25 and 45 said ‘cancel service’”.

Existing systems do not have post processing rules or the rules have no scope for incorporating additional inputs dynamically

Exemplary embodiments of disclosed systems and methods may provide a capability whereby using a dynamic rules processing system as described above will allow the user to incorporate inputs from different sources

Exemplary embodiments may further provide a capability wherein changes to the rules dynamically at any stage in the process are allowed

Exemplary embodiments may provide a capability wherein the speech grammar operands and operators can be modified dynamically

Exemplary embodiments may provide a capability wherein it allows having a repository for storage, management and retrieval of rules for pre-extraction, pre-speech processing and post speech processing in a uniform manner

These and other features and advantages of various disclosed exemplary embodiments are described in, or apparent from, the following detailed description of various exemplary embodiments of systems and methods according to this disclosure.

### SUMMARY OF THE INVENTION

In accordance with the foregoing, the following embodiments of a method and system for incorporating one or more inputs and defining and applying a plurality of rules for the different stages of speech and video analytics systems are provided.

In one embodiment of the invention, a repository is used to create, store and deploy pre and post speech analytics processing rules and speech grammar rules. These rules are then used to extract metadata and media into the system, create rules and expressions to search media and apply rules to the speech analytics searches. The rules in each of the above steps may be the same or different.

In another embodiment of the invention, rules are created to extract the metadata and media. In a different embodiment rules for defining the speech grammar expressions are created. In a different embodiment rules are created to process the results of the speech analytics searches.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1—is a flow chart showing one embodiment of creating and using rules for pre and post Speech Analytics processing and rules for defining the speech grammar. The rules for pre-speech analytics processing are used to define rules for metadata and media extraction The rules for post-speech analytics processing are used on the speech analytics results. The rules for defining speech grammar expressions are also shown

### DETAILED DESCRIPTION AND DISCLOSURE OF EMBODIMENTS OF THE INVENTION

Aside from the embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

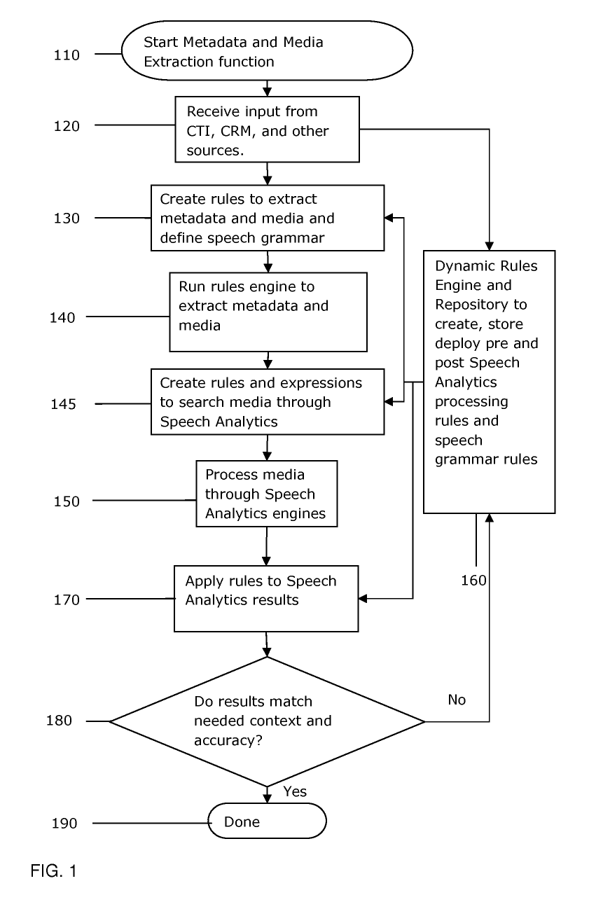

FIG. 1 illustrates a flow chart describing one embodiment of creating and using rules for pre and post speech analytics processing.

The pre-speech analytics processing rules are used to define the metadata and media that are extracted for said speech analytics and rules for searching said media. The rules include as input speech terms, metadata, CRM and other information.

The rules for post-speech analytics processing are used to process the speech analytics results to further refine said results. In accordance with the present invention, the function begins at block 110, starting said metadata and media extraction process.

At block 120, the function receives input from various CRM, CTI and other sources. This may be a push or a pull mechanism. In a pull mechanism the system retrieves the information from external or internal sources. In a push mechanism, information from the internal or external sources is pushed to the system. The input may be used by block 160 to create, store and deploy rules and by block 130 to used said rules

At block 130, rules are created with the inputs from block 120. Pre Speech Analytics processing rules may be created for:
1. Extraction of metadata and media from external systems for Speech Analytics processing.

2. Defining the speech grammar and expressions

3. Rules for searching the media including search terms, metadata information, CRM and other information using said grammar and expressions.

4. Rules can also be created for post Speech Analytics processing to derive relevant information from the speech analytics searches.

At block 140, the function runs the rules to extract metadata and media from external sources.

At block 145, the function creates rules for searching media with speech terms, metadata, CRM and other information, said rules are used to form grammar and search expressions

At block 150, the media extracted in block 140 is processed through the Speech Analytics engines using rules created at block 145.

At block 170 post speech processing rules are applied to the results of said Speech Analytics processing done in block 150

At block 180 it is determined if the results obtained match the defined context and accuracy. If the answer is no, the “no” branch is taken at block 180 and then the function proceeds to block 160

If there is no other processing to be done then the “yes” branch is taken and the process terminates at block 190.

At block 160 the function creates additional pre and post processing rules and proceeds to block 140 to repeat processing.

The process terminates at block 180 (for example, when all the pre and post processing is completed.

It can thus be seen that new and useful systems for creating, managing and deploying rules for pre and post speech analytics searches and rules for defining the speech grammar have been provided.

In view of the many possible embodiments to which the principles of this invention may be applied, it should be recognized that the embodiments described herein with respect to the drawing figures are meant to be illustrative only and should not be taken as limiting the scope of the invention. For example, those of skill in the art will recognize that the elements of the illustrative embodiment shown in software may be implemented manually or in hardware or that the illustrative embodiment can be modified in arrangement and detail without departing from the spirit of the invention. Therefore, the invention described herein contemplates all such embodiments as may come within the scope of the following claims and equivalents thereof.

I claim:

1. The method of using a dynamic rules engine with inputs from at least one source as a means for creating, storing and managing said rules, said method comprising:
A. receiving said inputs from said sources,
B. creating said rules in said rules engine,
C. storing said rules in said rules engine, and
D. managing said rules in said rules engine,
E. said rules applied to at least one of the speech analytics stages comprising extraction, defining the speech grammar, using said grammar in search expressions, searching, analysis and display of results of said speech analytics searches
whereby the context and accuracy of results of said searches are improved.

2. The method of claim 1 wherein said rules engine is attached to a repository.

3. The method of claim 1 wherein said inputs are from internal systems.

4. The method of claim 1 wherein said inputs are from external systems.

5. The method of claim 1 wherein said rules are combined with machine learning as a means of analyzing results.

6. The method of claim 1 wherein said rules are combined with statistical approaches as a means of analyzing results.

7. The method of claim 1 wherein said rules are combined with cybernetics as a means of analyzing results.

8. The method of claim 1 wherein said rules are combined with manual methods as a means of analyzing results.
